(19) United States
(12) Patent Application Publication
(10) Pub. No.: US 2007/0030594 A1
(43) Pub. Date: Feb. 8, 2007

(54) Tape recording head with overlapping read transducers

(76) Inventors: Robert Glenn Biskeborn, Hollister, CA (US); Jason Liang, San Jose, CA (US)

Correspondence Address: INTERNATIONAL BUSINESS MACHINES CORPORATION, 650 Harry Road, L2PA/J2C, INTELLECTUAL PROPERTY LAW, SAN JOSE, CA, 95120-6099, US

(21) Appl. No.: 11/197,563

(22) Filed: Aug. 4, 2005

(51) Int. Cl. G11B 5/29

(52) U.S. Cl. 360/129

(57) ABSTRACT

A tape recording head is provided comprising a substrate including a first plane deposited on the substrate comprising a linear array of read transducers spaced apart in a direction substantially perpendicular to the direction of linear motion of a recording tape relative to the magnetic head, and a second plane deposited on the substrate comprising a linear array of read transducers spaced apart in a direction substantially perpendicular to the direction of linear motion of the recording tape relative to the magnetic head, the second plane offset relative to the first plane so that the read transducers in the first plane overlap the read transducers of the second plane such that a first read transducer in the first plane and a second read transducer in the second plane together span the width of a written track on the tape. A method is provided for increasing the SNR ratio of readback data from a track recorded on a tape using a magnetic head having overlapping read transducers is provided.

### BACKGROUND OF THE INVENTION

1. Field of the Invention

The invention relates to magnetic tape recording heads, and more particularly to a tape recording head having overlapping read transducers to improve the signal-to-media noise ratio when reading contiguous data tracks.

2. Description of the Related Art

In magnetic storage systems, data is read from and written onto magnetic recording media utilizing magnetic transducers commonly referred to as magnetic heads. Data is written on the magnetic recording media by moving a magnetic recording head to a position over the media where the data is to be stored. The magnetic recording head then generates a magnetic field, which encodes the data into the magnetic media. Data is read from the media by similarly positioning the magnetic read head and then sensing the magnetic field of the magnetic media. Read and write operations are independently synchronized with the movement of the media to ensure that the data can be read from and written to the desired location on the media.

An important and continuing goal in the data storage industry is that of increasing the density of data stored on a medium. For tape storage systems, that goal has lead to increasing the track density on recording tape, and decreasing the thickness of the magnetic tape medium. However, the development of small footprint, higher performance tape drive systems has created various problems in the design of a tape head assembly for use in such systems.

In a tape drive system, magnetic tape is moved over the surface of the tape head at high speed. This movement generally entrains a film of air between the head and tape. Usually the tape head is designed to minimize the spacing between the head and the tape. The spacing between the magnetic head and the magnetic tape is crucial so that the recording gaps of the transducers, which are the source of the magnetic recording flux, are in intimate or near contact with the tape to effect efficient signal transfer, and so that the read element is in intimate or near contact with the tape to provide effective coupling of the magnetic field from the tape to the read element.

A flat contour thin film tape recording head for a bi-directional tape drive is described in commonly assigned U.S. Pat. No. 5,905,613 to Biskeborn and Eaton. The flat contour head comprises a flat transducing surface on a substrate having a row of thin film transducers formed on a surface on one side of the substrate which forms a gap. The substrate with the row of transducers is called a “rowbar substrate”. The transducers are protected by a closure of the same or similar ceramic as the substrate. For a read-while-write bi-directional head which requires that the read transducer follows behind the write transducer, two rowbar substrates with closures are mounted in a carrier facing one another. The recording tape overwraps the comers of both substrates and closures with an angle sufficient to scrape (skive) the air from the surface of the tape and not so large as to allow air to reenter between the tape and the transducing surface after the tape passes the corner. By scraping the air from the surface of the moving tape, a vacuum forms between the tape and the flat transducing surface holding the tape in contact with the transducing surface. At the comers of the air skiving edge, bending of the recording tape due to the overwrap results in separation of the tape from the transducing surface for a distance that depends on the wrap angle, the tape thickness and the tape tension. The transducers must be spaced from the comers of the air skiving edges at a sufficient distance to allow the vacuum between the tape and the transducing surface to overcome this separation.

An important and continuing goal in the data storage industry is that of increasing the density of data stored on a medium. For tape storage systems, that goal has lead to increasing the track density on recording tape. Because of the ongoing desire to increase data storage density on tape media, it is desirable to reduce the track width and increase the number of tracks recorded across the tape. Contiguous data tracks may be used for which there is a minimal or no space or guard zone separating the tracks. However positional misregistration of the read heads on the track usually requires using a read transducer having a width significantly narrower than the track width resulting in a low signal-to-noise (SNR) ratio for the readback signal. Therefore, there is an ongoing need for a multitrack tape recording head that overcomes this limitation and provides an array of read transducers capable of reading very closely spaced or abutting data tracks with an improved SNR.

### SUMMARY OF THE INVENTION

In accordance with the principles of the present invention, there is disclosed a tape recording head comprising a substrate including a first plane deposited on the substrate comprising a linear array of read transducers spaced apart in a direction substantially perpendicular to the direction of linear motion of a recording tape relative to the magnetic head, and a second plane deposited on the substrate comprising a linear array of read transducers spaced apart in a direction substantially perpendicular to the direction of linear motion of the recording tape relative to the magnetic head, the second plane offset relative to the first plane so that the read transducers in the first plane overlap the read transducers of the second plane such that a first read transducer in the first plane and a second read transducer in the second plane together span the width of a written track on the tape.

Another embodiment of the invention discloses a tape recording head comprising a substrate including a first plane deposited on the substrate comprising a linear array of read transducers spaced apart in a direction substantially perpendicular to the direction of linear motion of a recording tape relative to the magnetic head, a second plane deposited on the substrate comprising a linear array of read transducers spaced apart in a direction substantially perpendicular to the direction of linear motion of the recording tape relative to the magnetic head, the second plane offset relative to the first plane so that the read transducers in the first plane overlap the read transducers of the second plane such that a first read transducer in the first plane and a second read transducer in the second plane together span the width of a written track on the tape, and a third plane deposited on the substrate comprising a linear array of write transducers spaced apart in a direction substantially perpendicular to the direction of linear motion of the recording tape relative to the magnetic head.

Another embodiment of the invention discloses a method of increasing the signal-to-media noise ratio (SNR) of readback data from a track recorded on a tape using a magnetic head having overlapping read transducers comprising writing a track on a recording tape, providing an overlapping pair of read transducers spanning the width of the written track, reading output signals of the pair of read transducers simultaneously, determining which read transducer is positioned 100% over the written track, and directing the output signal of the read transducer determined to be 100% over the written track to a read/write channel of a magnetic recording system.

The above as well as additional objects, features, and advantages of the present invention will become apparent in the following detailed description.

### BRIEF DESCRIPTION OF THE DRAWINGS

For a fuller understanding of the nature and advantages of the present invention, as well as the preferred mode of use, reference should be made to the following detailed description read in conjunction with the accompanying drawings. In the following drawings, like reference numerals designate like or similar parts throughout the drawings:

FIG. 1 is a cross-sectional end view, not to scale, of a read-while-write bi-directional flat contour linear tape recording head;

FIG. 2 is a perspective view, not to scale, of a rowbar substrate and closure assembly of the tape recording head of FIG. 1;

FIG. 3a is a cross-sectional view, not to scale, of the gap region of a rowbar substrate and closure assembly;

FIG. 3b is a top view, not to scale, of one read-write transducer portion of the gap region of FIG. 3a.

FIG. 4a is transducer surface view, not to scale, of a conventional read MR transducer relative to data tracks on a recording tape;

FIG. 4b is a transducer surface view, not to scale, of the overlapping read MR transducers of the present invention relative to data tracks on a recording tape;

FIG. 5 is a simplified schematic diagram of the series connection of the tandem pairs of overlapping read transducers;

FIG. 6 is a transducer surface view, not to scale, of a combined read-write head having write transducers on a third layer displaced in between the read transducers;

FIG. 7 is a flow chart of a method of improving the signal-to-media noise ratio (SNR) of readback data from a track recorded on a tape according to the present invention; and

FIG. 8 is a simplified diagram of a magnetic tape recorder system using the magnetic recording head of the present invention.

### DETAILED DESCRIPTION OF THE PREFERRED EMBODIMENT

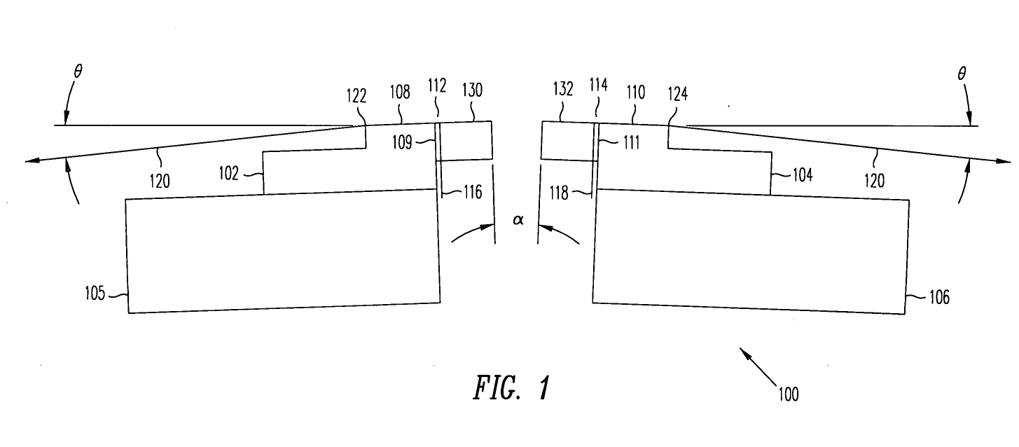

FIG. 1 illustrates a bi-directional read-while-write flat contour head 100 using the present invention. Rowbar substrates 102 and 104 of a wear resistant material, such as the substrate ceramic typically used in magnetic disk drive heads, are mounted in carriers 105 and 106 fixed at a small angle α with respect to each other. The ceramic rowbar substrates 102 and 104 are provided with flat tape support surfaces 108 and 110 and gap surfaces 109 and 111 and a row of transducers at the surfaces of gap regions 112 and 114. Electrical connection cables 116 and 118 connect the transducers to the read/write channel of the associated tape drive. The wrap angle θ of the tape 120 at edges 122 and 124 going onto the flat tape support surfaces 108 and 110, respectively, and angle α/2 are usually between ⅛ degree and 4.5 degrees. The rows of transducers are protected by closures 130 and 132 made of the same or similar ceramic as the rowbar substrates 102 and 104.

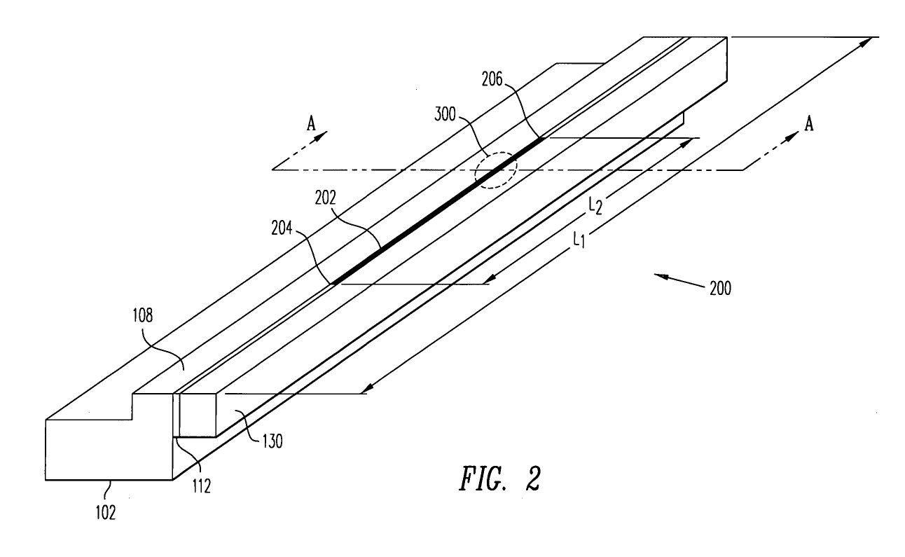

FIG. 2 is a perspective view of a rowbar substrate and closure assembly 200 comprising the rowbar substrate 102, the closure 130 and the gap region 112 shown in FIG. 1. The assembly 200 has a length L₁ greater than the width of the magnetic recording tape 120 extending in direction perpendicular to the direction of the linear motion of the tape across the head 100. The flat tape support surface 108 supports the tape as it moves across the head. A row of transducers 202 positioned in the gap region 112 and having a length L₂ less than the width of the tape is centered along the length direction of the assembly 200. The row of transducers 202 comprises a plurality of read and write transducers for reading and writing data on the magnetic recording tape. Servo read transducers which may be located at first and second ends 204 and 206 of the row of transducers 202 are used to position the read and write transducers over data tracks written on the magnetic recording tape.

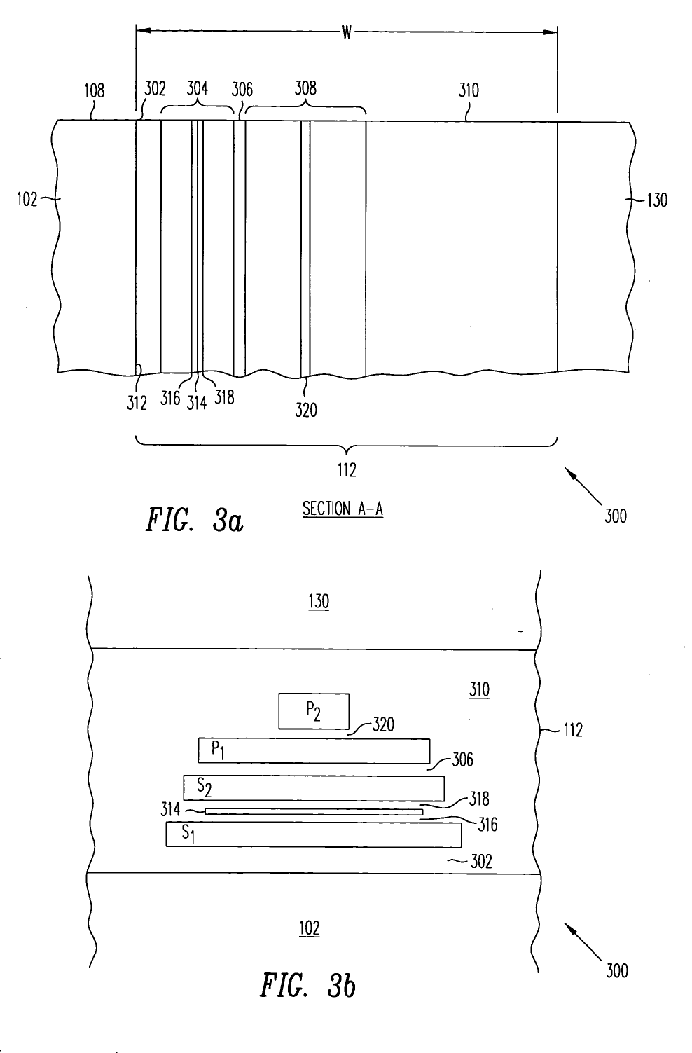

FIG. 3a shows sections A-A indicated on FIG. 2 as area 300 through the middle region of the rowbar substrate and closure assembly 200 near the tape support surface 108 where the row of transducers 202 are present in a conventional head. FIG. 3b is a top view of one read-write transducer portion of the gap region of FIG. 3a. The gap 112 comprises an undercoat 302 of aluminum oxide, a read transducer 304, an insulation layer 306 of aluminum oxide, a write transducer 308 and an overcoat 310 of aluminum oxide sandwiched between the rowbar substrate 102 and the closure 130. These elements are formed on the rowbar substrate surface 312 by wafer deposition methods well known to those skilled in the art. Closure 130 is then fixed to the overcoat 310 to protect the transducers in the gap region. Typically, the gap 112 has a width W of about 25-35 microns. The read transducer 304 comprises a transducer 314 sandwiched between first and second shields S₁ and S₂, respectively, formed of a magnetic material such as permalloy. The transducer 314, which may be an anisotropic magnetoresistive (AMR) sensor, a giant magnetoresistive (GMR) sensor or a tunneling magnetoresistive (TMR) sensor, is electrically insulated from S₁ and S₂ by insulator layers 316 and 318 formed of aluminum oxide. The inductive write transducer 308 comprises a write gap 320 formed of nonmagnetic material between first and second write poles P₁ and P₂, respectively, formed of magnetic material such as a high moment nickel-iron alloy. After the deposition of the layers comprising the gap 112 and attachment of the protective closure 130, the tape support surface 108 is lapped to obtain the desired read sensor stripe height and poletip dimensions of poles P1 and P2 and a flat or cylindrical surface finish. The shield S2 and pole P1 are sometimes merged to form a single layer.

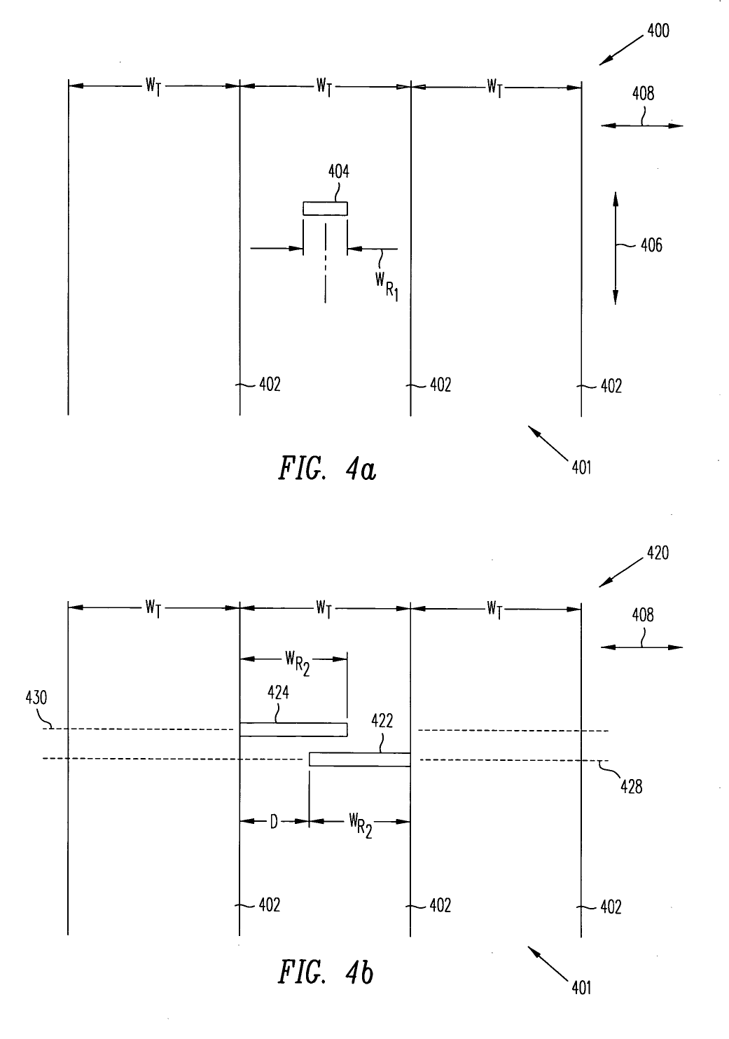

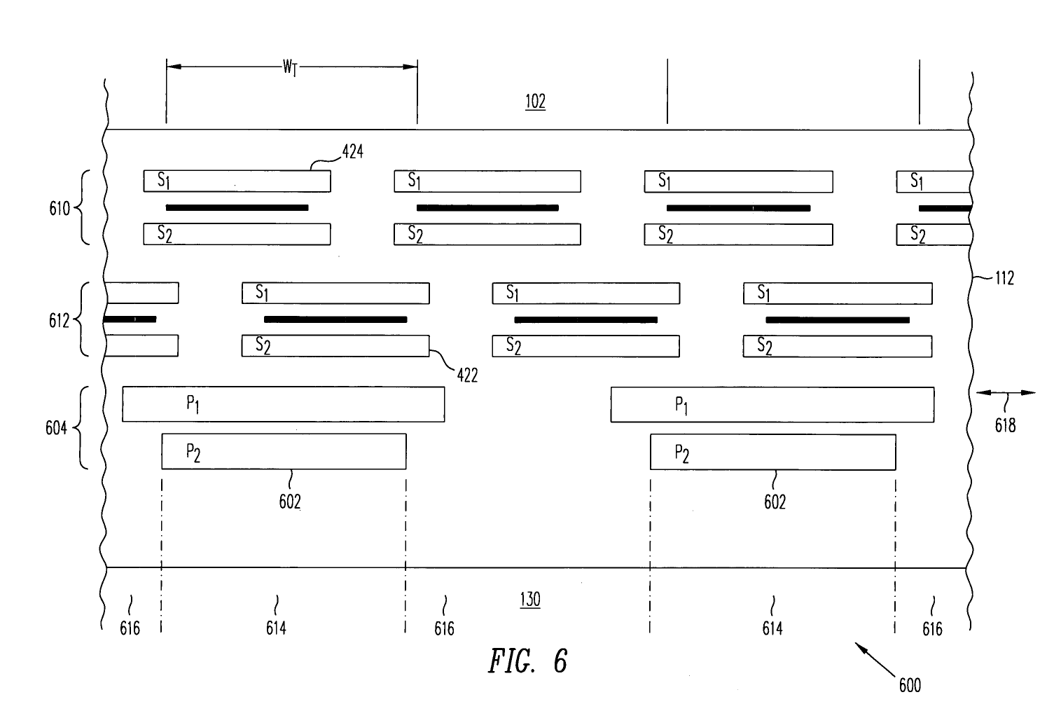

FIG. 4a is a transducer surface view, not to scale, of a conventional read transducer arrangement 400 shown relative to data tracks 402 on a recording tape 401. An array of data tracks 402 are written along the length of the tape in a direction parallel to the forward and backward directions of tape travel indicated by the double-headed arrow 406. Write transducers (not shown) write the tracks 402. The written tracks have a width W_{T} and there may or may not be a space or guard zone separating adjacent tracks. Read MR transducers 404 (only one transducer is shown) are formed in a single plane spaced apart in a row extending in a direction perpendicular to the direction of tape travel indicated by the double-headed arrow 408. In the interest of clarity, shields S₁ and S₂ of the read transducer are not shown in FIG. 4a. The centers of the MR transducers 404 are spaced apart a distance equal to a multiple of the width W_{T} of the contiguous tracks.

Ideally, the MR transducers 404 should have an active width W_{R} approaching as closely as possible the width W_{T} of the data tracks 402 so that the amplitude of the readback signal from each transducer is as large as possible. The active width of the read transducer, also simply referred to as the width of the transducer, is the width of the active portion of the transducer that is sensitive to magnetic data recorded on the recording tape. As the tape travels past the transducer array in the directions 406, actuator positioning error relative to the tape 401 in the directions 408 perpendicular to the direction 406 of the tape travel result in positional misregistration of the MR transducers 404 relative to the centers of the tracks 402. If the width of the MR transducer is too great, misregistration can cause part of the MR transducer to pass over the neighboring track resulting in degradation of the readback signal. To prevent this misregistration problem, the width W_{R1} of the MR transducer 404 is reduced by an amount equal to the total positional misregistration that is expected for the read transducer with respect to the tape. For example, if the track width W_{T} is 4 microns and the total positional misregistration is 3 microns, the conventional MR transducer width W_{R1} would be reduced to 1 micron to ensure that the entire MR transducer 404 remains over the desired data track 402 at all times. Reduction of the MR transducer width W_{R1} results in a proportionate reduction in the readback signal amplitude but only a square root reduction of media noise with the net effect being a concomitant reduction of the signal-to-media noise ratio (SNR). Thus, the SNR is proportional to the square root of W_{R1}, and so halving W_{R1} reduces the SNR by √2 or 3 dB.

FIG. 4b is a transducer surface view, not to scale, of a read MR transducer arrangement 420 according to the present invention shown relative to data tracks 402 on a recording tape 401. Two read element planes are fabricated on top of one another. Read MR transducers 422 are formed in a first plane 428 and MR transducers 424 are formed in a second plane 430 over the first plane 428. In the interest of clarity, shields S₁ and S₂ of the read transducers are not shown. Note that S2 of the first read head and S1 of the second read head may be merged. The MR transducers 422 in the first plane 428 form a spaced apart row extending in a direction perpendicular to the direction of tape travel indicated by the double-headed arrow 408. Similarly, the read transducers 424 in the second plane 430 form a spaced apart row extending in a direction perpendicular to the direction of tape travel indicated by the double-headed arrow 408. The two planes 428 and 430 are shifted relative to one another by an amount D that depends on track width and actuator positioning error. Having one MR transducer from each of the planes 428 and 430 positioned over a track 402 allows the use of MR transducers 422 and 424 having greater widths W_{R2} than possible in the conventional transducer arrangement 400 of FIG. 4a and ensures that one MR transducer is always fully on track and 100% over data in that track. MR transducers 422 and 424 overlap such that together the two transducers span the width of the written track 402 on the tape.

In FIG. 4b a single pair of MR transducers 422 and 424 is shown over a the track 402. However, the MR transducers may be located spaced apart in the perpendicular direction 408 by some integral multiple of the track width WT. Data on adjacent tracks is then read on subsequent tape passes by stepping the read head to locate the transducers sequentially over each of the adjacent tracks 402.

The two planes 428 and 430 are displaced or shifted relative to one another by an amount D equal to half the total positional misregistration. The MR transducer width W_{R2} is given by the track width W_{T} minus half the total positional misregistration. For the example discussed with respect to the conventional read transducer arrangement 400 of FIG. 4a where the track width is 4 microns and the total positional misregistration is 3 microns, with the read transducer arrangement 420 of the invention, the MR transducer width W_{R2} is 4− 3/2=2.5 microns. The two planes 428 and 430 are displaced 1.5 microns and aligned to the tape during reading such that the center of the pair of MR transducers 422 and 424 is in the center of the associated track 402. For this example, the increased width of the read transducer from W_{R1}=1 micron to W_{R2}=2.5 microns results in an increase of the SNR of 10 log(2.5)=4 dB for the MR transducer arrangement 420 of this invention compared to the conventional arrangement 400.

The increased SNR obtained with the overlapping MR transducers 422 and 424 of the invention enables better error detection margin which may allow use of anisotropic magnetoresistive (AMR) sensors instead of the more delicate and complex giant magnetoresistive (GMR) sensors. The magnetoresistive (MR) sensors are operated in a constant current mode often by using relatively large (approximately 10× the MR element resistance) series resistors R to ensure that current modulation due to resistance modulation produces a negligible signal decline.

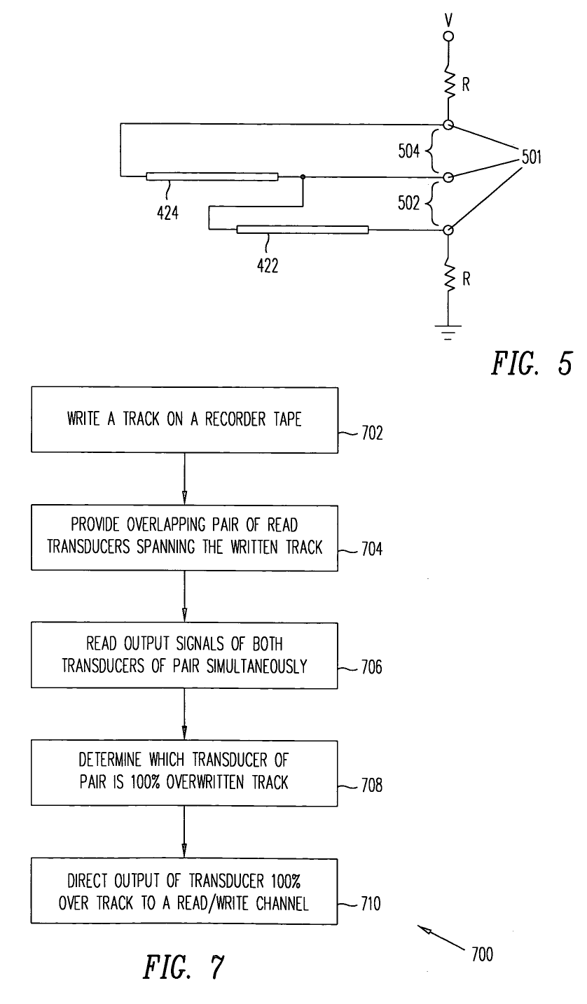

The tandem pairs of MR transducers 422 and 424 disposed one in each of layers 428 and 430, respectively, may be wired in series and biased as a unit as shown in the simplified schematic diagram of FIG. 5. The advantage of wiring the pair in this way is that each pair requires only three leads 501 instead of four leads for easier cabling implementation. Output signal 502 read across read transducer 422 and output signal 504 read across read transducer 424 are read simultaneously and buffered to compensate for the small phase difference between the two. In general, timing based servo (TBS) servo readback data in combination with read signal analysis determines which member of the pair of transducers is 100% on track, and the output signal of that read transducer is multiplexed to the read/write channel. If desired, the signals from each reader can be processed to remove the unwanted cross talk and then summed for even better signal to electronic noise.

FIG. 6 is a transducer surface view, not to scale, of a combined read-write head 600 having a third plane 604 comprising write transducers 602 preferably positioned midway between the MR read transducers 422 and 424 on first and second planes 610 and 612, respectively, according to the present invention. The write transducers 602 write data on tracks 614 on a first pass of the recording tape. Alternate tracks 616 are written on a second pass by moving the write transducers 602 on the read-write head 600 by means of an actuator (not shown) in a direction indicated by arrow 618 perpendicular to the direction of linear motion of the tape past the head 600. Alternatively, a second layer of write transducers (not shown) offset from the transducers 602 may be formed on a fourth plane to allow the tracks 616 to be written simultaneously with the tracks 614 in a single pass of the recording tape.

In FIG. 6 MR transducers 422 and 424 are shown over all of tracks 614 and 616, respectively. However, because of spacing constraints in locating the transducers over adjacent tracks, the MR transducers may be spaced apart on planes 610 and 612 in the perpendicular direction 618 by some integral multiple of the track pitch. Data on adjacent tracks is then read on subsequent tape passes by stepping the read head to locate the read transducers sequentially over each of the adjacent tracks. Similarly, write transducers 602 may be spaced apart in the perpendicular direction 618 by an integral number of track pitches greater than 2 and data may be written on the adjacent tracks on subsequent tape passes by stepping the head to locate the write transducers sequentially over each of the adjacent tracks.

FIG. 7 is a flow chart of a method 700 for increasing the signal-to-media noise ratio (SNR) of readback data from a track recorded on a tape using a magnetic head having overlapping read transducers according to the present invention. With reference to FIGS. 4a, 4b, 5, 6 and 8, in step 702 a write transducer 602 records (writes) a track 614 on a recording tape 401. In step 704, an overlapping pair of read transducers 422, 424 spanning the written track 614 are provided. In step 706, the output signals 502, 504 of the pair of read transducers 422, 424 are read simultaneously and in step 708, the output signals 502 and 504 are monitored to determine which read transducer of the pair 422 and 424 is positioned 100% over the written track 614. In step 710, the output signal of the read transducer determined to be 100% over the written track 614 is directed to the read/write channel 808 of the recorder system 800. This can be done by analysis of the two signals, for example, by performing a fast fourier transform (FFT) and selecting the signal having fewer frequency peaks. Alternatively, servo position signal which gives head position may be used in determining which of the two readers is fully on track. Further improvement of the SNR may be obtained by processing the signals from both heads to subtract off the difference and to sum the two “good” signals to average out some of the media noise and some of the electronic noise.

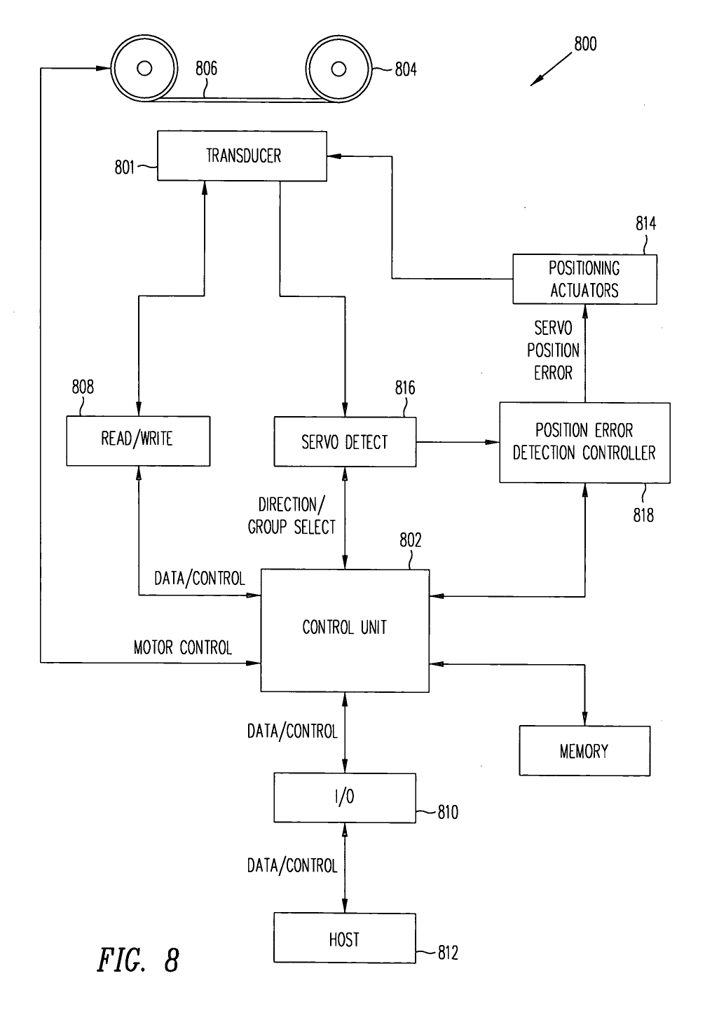

FIG. 8 illustrates an embodiment of a magnetic tape recorder or tape drive system 800 incorporating the magnetic recording head having overlapping read transducers of the present invention. A tape drive control unit 802 provides a motor control signal to rotate tape reels 804 and move magnetic tape 806 across the read/write transducer head 801. Read/write channel 808 transmits read/write signals between the read/write transducer 801 and the control unit 802. The data is communicated through I/O channel 810 with host 812. Lateral positioning of the transducer 801 with respect to the tape 806 is accomplished by positioning actuator 814. The lateral repositioning is required to access the various tracks of the tape 806 with the transducer 801. A servo system may be employed for accurate lateral repositioning of the transducer 801. An exemplary servo system includes a servo detector 816 to detect both the track that the head is currently on and whether the head is off center. Control unit 802 indicates the track address of a desired new track to position error detection controller 818 for repositioning the head. Servo detector 816 indicates the current track to position error detection controller 818, and the controller provides a servo position error signal to positioning actuator 814 which repositions the transducer 801 to the new track. The servo system also provides track following signals to positioning actuator 814 so that the tracks on tape 806 may be closely spaced.

While the present invention has been particularly shown and described with reference to the preferred embodiments, it will be understood by those skilled in the art that various changes in form and detail may be made without departing from the spirit, scope and teaching of the invention. Accordingly, the disclosed invention is to be considered merely as illustrative and limited only as specified in the appended claims.

We claim:

1. A magnetic head comprising:
a substrate;
a first plane deposited on the substrate, said first plane comprising a linear array of read transducers spaced apart in a direction substantially perpendicular to the direction of linear motion of a recording tape relative to the magnetic head; and
a second plane deposited on the substrate, said second plane comprising a linear array of read transducers spaced apart in a direction substantially perpendicular to the direction of linear motion of the recording tape relative to the magnetic head, the second plane offset relative to the first plane so that the read transducers in the first plane overlap the read transducers of the second plane such that a first read transducer in the first plane and a second read transducer in the second plane together span the width of a written track on the tape.

2. The magnetic head recited in claim 1, wherein the first plane is offset relative to the second plane by an amount equal to half the total positional misregistration of the magnetic head with respect to the tape.

3. The magnetic head recited in claim 1, wherein the first read transducer and the second read transducer are wired in series.

4. A magnetic head comprising:
a substrate;
a first plane deposited on the substrate, said first plane comprising a linear array of read transducers spaced apart in a direction substantially perpendicular to the direction of linear motion of a recording tape relative to the magnetic head;
a second plane deposited on the substrate, said second plane comprising a linear array of read transducers spaced apart in a direction substantially perpendicular to the direction of linear motion of the recording tape relative to the magnetic head, the second plane offset relative to the first plane so that the read transducers in the first plane overlap the read transducers of the second plane such that a first read transducer in the first plane and a second read transducer in the second plane together span the width of a written track on the tape; and
a third plane deposited on the substrate, said third plane comprising a linear array of write transducers spaced apart in a direction substantially perpendicular to the direction of linear motion of the recording tape relative to the magnetic head.

5. The magnetic head recited in claim 4, wherein the first plane is offset relative to the second plane by an amount equal to half the total positional misregistration of the magnetic head with respect to the tape.

6. A magnetic recorder system, comprising:
a magnetic recording tape;
a tape drive for moving the magnetic recording tape linearly;
a magnetic head for magnetically recording data on the magnetic recording tape and for sensing magnetically recorded data on the magnetic recording tape, said magnetic head comprising:
a substrate;
a first plane deposited on the substrate, said first plane comprising a linear array of read transducers spaced apart in a direction substantially perpendicular to the direction of linear motion of a recording tape relative to the magnetic head;
a second plane deposited on the substrate, said second plane comprising a linear array of read transducers spaced apart in a direction substantially perpendicular to the direction of linear motion of the recording tape relative to the magnetic head, the second plane offset relative to the first plane so that the read transducers in the first plane overlap the read transducers of the second plane such that a first read transducer in the first plane and a second read transducer in the second plane together span the width of a written track on the tape;
an actuator for positioning the magnetic head to access various tracks on the magnetic recording tape; and
a read/write channel coupled electrically to the magnetic head for magnetically recording data on the magnetic recording tape and for reading data recorded on the magnetic recording tape.

7. The magnetic recorder system recited in claim 6 further comprising:
a third plane deposited on the substrate, said third plane comprising a linear array of write transducers spaced apart in a direction substantially perpendicular to the direction of linear motion of the recording tape relative to the magnetic head.

8. The magnetic recorder system recited in claim 6, wherein the first plane is offset relative to the second plane by an amount equal to half the total positional misregistration of the magnetic head with respect to the tape.

9. A method of increasing the signal-to-media noise ratio (SNR) of readback data from a track recorded on a tape comprising:
writing a track on a recording tape;
providing an overlapping pair of read transducers spanning the width of the written track;
reading output signals of the pair of read transducers simultaneously;
determining which read transducer is positioned 100% over the written track; and
directing the output signal of the read transducer determined to be 100% over the written track to a read/write channel of a magnetic recording system.

10. The method recited in claim 9 wherein determining which read transducer is positioned 100% over the written track is determined from the output signals of the pair of read transducers.

11. The method recited in claim 9 wherein determining which read transducer is positioned 100% over the written track is determined from the servo position signal.
